(19) United States
(12) Patent Application Publication
(10) Pub. No.: US 2013/0009625 A1
(43) Pub. Date: Jan. 10, 2013

(54) TRANSFORMER

(76) Inventor: Osamu Ide, Tokyo (JP)

(21) Appl. No.: 13/635,358

(22) PCT Filed: Jul. 15, 2011
(86) PCT No.: PCT/JP2011/066234

§ 371 Date: Sep. 14, 2012

(30) Foreign Application Priority Data
Jul. 15, 2010 (JP) 2010-160822
Mar. 14, 2011 (JP) 2011-056023

(51) Int. Cl. H01F 30/00; H01F 27/24

(52) U.S. Cl. 323/362; 323/355

(57) ABSTRACT

The object is to provide a transformer capable of outputting more efficiently than conventional transformers the electric power outputted in a secondary output in response to a primary input.

A transformer including two or more cores, and a primary coil and a secondary coil which are wound around the cores, wherein two or more magnetic circuits formed by the cores and the primary coil or the secondary coil have a combination generating lines of magnetic force which repulsively act each other, and the cores in which said magnetic circuit forms the combination generating lines of magnetic force which repulsively act each other are provided with at least one or more gaps.

### FIELD OF THE INVENTION

The present invention relates to a transformer capable of improving power conversion efficiency.

### BACKGROUND OF THE INVENTION

FIGS. 27 and 28 show examples of a basic magnetic field structure using a conventional transformer.

In a transformer shown in FIG. 27, a primary coil L1 is wound around one arm A1 of four arms A1 to A4 of a rectangular core M1, which is in parallel with a longitudinal direction of the figure, and a secondary coil L2 is wound around the arm A3 opposing to the arm A1, wherein input current is supplied to both ends of the primary coil L1 and output voltage is taken from both ends of the secondary coil L2. At this point, line of magnetic force F flows in a magnetic circuit sequentially passing through A1 to A4 in the core M1.

A transformer as shown in FIG. 28 uses a core (so-called EI-type core) which includes an arm A5 connecting horizontal arms A2 and A4 substantially at the center of core in a horizontal direction of the transformer shown in FIG. 27. In this transformer, the primary coil L1 and secondary coil L2 are wound around the arm A5. In this case, two magnetic circuits are formed: one magnetic circuit is formed by line of magnetic force F1 sequentially passing through the arms A5, A2, A1, and A4, and the other magnetic circuit is formed by line of magnetic force F2 sequentially passing through the arms A5, A2, A3, and A4.

As described above, in the conventional structure of transformer, substantially no repulsive magnetic field such as north pole vs. north pole or south pole vs. south pole is generated due to the input current of primary coil in the internal magnetic field structure (magnetic circuit). In FIG. 28, although the line of magnetic force F1 and the line of magnetic force F2 appear to oppose each other at the connecting part from the arm A4 to arm A5 in the lower side of core M1, this is because the routes of two lines of magnetic force F1, F2 gather together at that part, and not because the repulsive magnetic field is formed.

Further, a patent literature 1 shows an example using a transformer including EI-type core as a high frequency pulse transformer.

### PRIOR ART LITERATURE

### Patent Literature

[Patent Literature 1] Laid-open patent publication 2009-290061

Non-Patent Literature [Non-Patent Literature 1] Osamu Ide, “Journal of APPLIED PHYSICS” (U.S.A.), American Institute of Physics, 1 Jun. 1995, Vol. 77, No. 11, p6015-6020

[Non-Patent Literature 2] Osamu Ide, “NASA/CP2000-210291 Fifth International Symposium on Magnetic Suspension Technology” (U.S.A.), National Aeronautics and Space Administration, July 2000, p705-719

### SUMMARY OF THE INVENTION

### Problems to be Solved by the Invention

The object of the present invention is to provide a transformer capable of outputting more efficiently than conventional transformers the electric power appearing in a secondary output in response to a primary input.

### Solution to Problems

A transformer according to the present invention is a transformer including two or more cores and a primary coil and a secondary coil wound around the above cores, wherein two or more magnetic circuits formed by the above cores and the above primary coil or secondary coil have a combination generating lines of magnetic force which repulsively act each other, and the cores forming the combination where the magnetic circuits generate lines of magnetic force which repulsively act each other are provided with at least one or more gaps.

Further, just after the power supply to the above primary coil is switched from OFF to ON or ON to OFF, the electric power generated in the above secondary coil is taken outside of the transformer.

### Advantage of the Invention

In such a transformer according to the present invention, the electromotive force generated in each coil by its opposing coil on the basis of a Lenz's law, which is caused by opposing repulsive magnetic fields, accelerates the current of the opposing coil, whereby the current of the opposing coil is increased, and thus output electric power can be more efficiently taken out.

### BRIEF DESCRIPTION OF THE DRAWINGS

FIG. 1 is a first view illustrating the principle of the present invention.

FIG. 2 is a second view illustrating the principle of the present invention.

FIG. 3 is a third view illustrating the principle of the present invention.

FIG. 4 is a fourth view illustrating the principle of the present invention wherein two coils are provided on the power source side.

FIG. 5 is a fifth external perspective view illustrating the principle of the present invention wherein two coils are provided on the power source side.

FIG. 6 is a sixth view illustrating the principle of the present invention.

FIG. 7 is a seventh view illustrating the principle of the present invention.

FIG. 8 is a structural view illustrating a first embodiment of a transformer according to the present invention.

FIG. 9 is a perspective view illustrating a first embodiment of a transformer according to the present invention.

FIG. 10 is a structural view illustrating a second embodiment of a transformer according to the present invention.

FIG. 11 is a perspective view illustrating a second embodiment of a transformer according to the present invention.

FIG. 12 is a structural view illustrating a third embodiment of a transformer according to the present invention.

FIG. 13 is a perspective view illustrating a third embodiment of a transformer according to the present invention.

FIGS. 14(a) and 14(b) are connection wiring diagrams illustrating the wire connection states of each coil in the third embodiment of a transformer according to the present invention, and FIG. 14(a) is a connection wiring diagram when the primary coil and the secondary coil are connected in parallel, while FIG. 14(b) is a connection wiring diagram when the primary coil and the secondary coil are connected in series.

FIG. 15 is a structural view illustrating a fourth embodiment of a transformer according to the present invention.

FIG. 16 is a perspective view illustrating a fourth embodiment of a transformer according to the present invention.

FIG. 17 is a connection wiring diagram illustrating the wire connection state of each coil in the fourth embodiment of a transformer according to the present invention.

FIG. 18 is a structural view illustrating a fifth embodiment of a transformer according to the present invention.

FIG. 19 is a perspective view illustrating a fifth embodiment of a transformer according to the present invention.

FIG. 20 is a structural view illustrating a sixth embodiment of a transformer according to the present invention.

FIG. 21 is a perspective view illustrating a sixth embodiment of a transformer according to the present invention.

FIG. 22 is a perspective view illustrating a seventh embodiment of a transformer according to the present invention.

FIG. 23 is a structural view when the transformer is viewed from the direction of arrow A in FIG. 22.

FIG. 24 is a structural view when the transformer is viewed from the direction of arrow B in FIG. 22.

FIG. 25 is a structural view when the transformer is viewed from the direction of arrow C in FIG. 22.

FIG. 26 is a connection wiring diagram illustrating the wire connection state of each coil in the seventh embodiment of a transformer according to the present invention.

FIG. 27 is a structural view illustrating an example of conventional transformer.

FIG. 28 is a structural view illustrating another example of conventional transformer.

### DESCRIPTIONS OF THE INVENTION

Hereinafter, an embodiment of the present invention is described in detail with reference to the accompanying drawings.

First, the principle of the present invention is described.

A transformer according to the present invention is a transformer having a magnetic structure such that the magnetic fields generated by two or more coils repulsively act each other. The advantage of the present invention is that the electromotive force generated in each coil by its opposing coil on the basis of a Lenz's law, which is caused by repulsive magnetic fields generated by two opposing coils, accelerates the current of the opposing coil, whereby the current of the opposing coil is increased. As such, for example, in a state where a transient change in current is great, that is, in a short period such as just after On or Off of a switch, it is possible to generate a larger change in coil current by comparatively small input voltage.

As a result, the improvement of transformer efficiency can be expected.

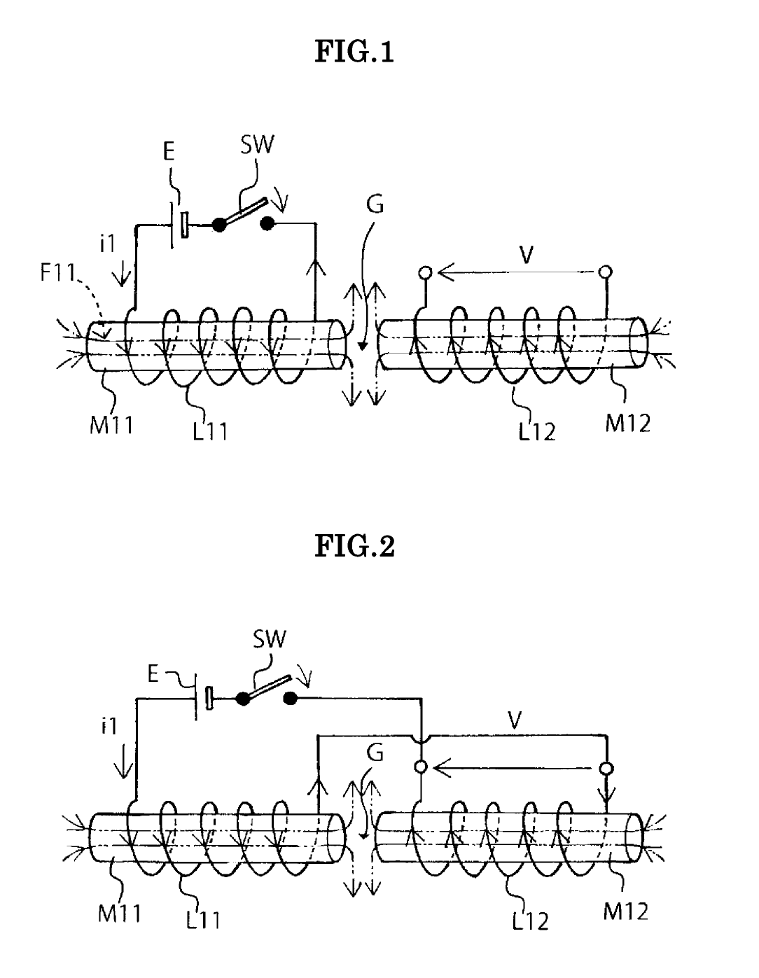

Hereinafter, the principle is described in detail with reference to FIGS. 1, 2 and 3.

FIG. 1 shows a state where coils L11, L12 are wound in the same winding direction around rod-shaped magnetic cores M11 and M12, and the wound coils L11 and L12 have one of the magnetic poles opposed each other with a gap G in the middle part. And, one coil L1 is connected to a DC power source E via a switch SW.

Just after the Switch SW is turned on, current i1 flows from the DC power source E to the coil L11 so that a line of magnetic force F11 is generated in the core M11 as shown by dot-dot dash line in the figure. When in a state where current i1 is increased, an induced electromotive force V is generated in the opposing coil L12 on the basis of a Lenz's law. The induced electromotive force V is directed on the basis of a Lenz's law such that the inductive current generated in the coil L12 cancels the magnetic field generated by the coil L11. That is, the magnetic field generated by the inductive current in coil L12 and the magnetic field generated in the coil L11 are oppositely directed.

Assuming that the two coils L11, L12 are connected in series as shown in FIG. 2, a circuit is configured such that the magnetic fields generated in the two coils repulsively act each other.

In this case, when the switch SW is turned on and current starts to flow from the DC power source E, the direction of induced electromotive force generated in the coil L12 coincides with the direction of current flowing in the coil L12. In the meantime, the current flowing from the DC power source E to the coil L12 generates an induced electromotive force in the opposing coil L11 in the same direction as the direction of current from the DC power source.

As a result, in a short period of time when current is increased, just after the switch SW is closed, the current of coil L11 and L12 is mutually accelerated by induced electromotive forces generated respectively. That is, the coils L11, L12 opposing each other with a gap cause the current increase phenomenon of generating current that is greater than the current generated when each coil is separately provided.

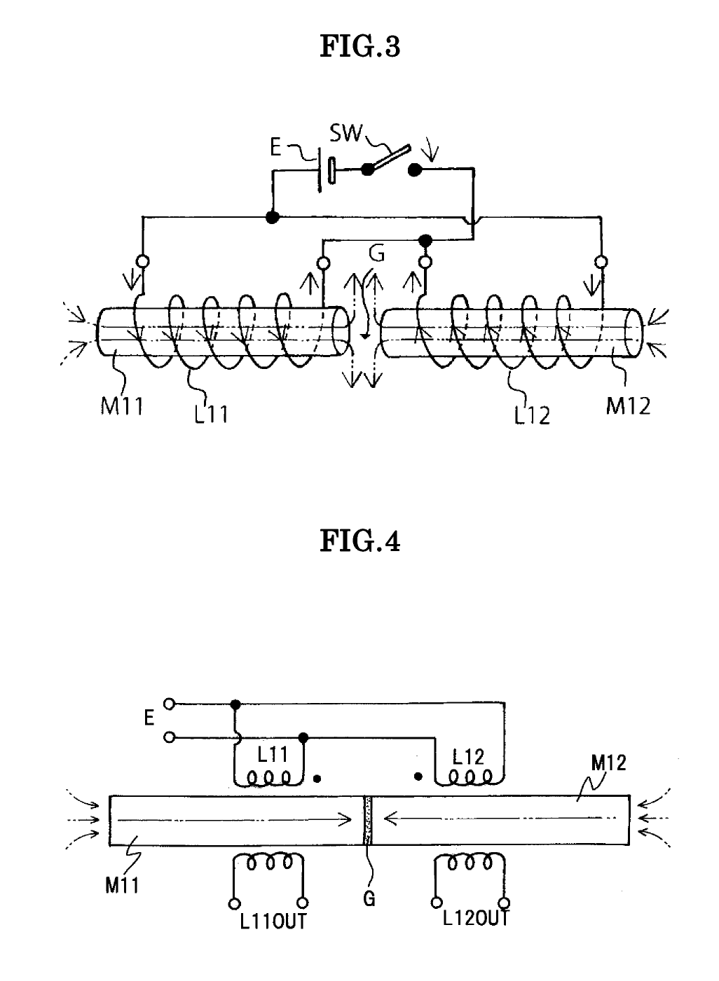

Further, FIG. 3 shows that the two coils L11, L12 are connected in parallel, which gives the same effect as the case when the two coils L11, L12 are connected in series as shown in FIG. 2. As a matter of course, the inductance of the circuit becomes less in the parallel connection than in the serial connection, whereby more precipitous current can be obtained.

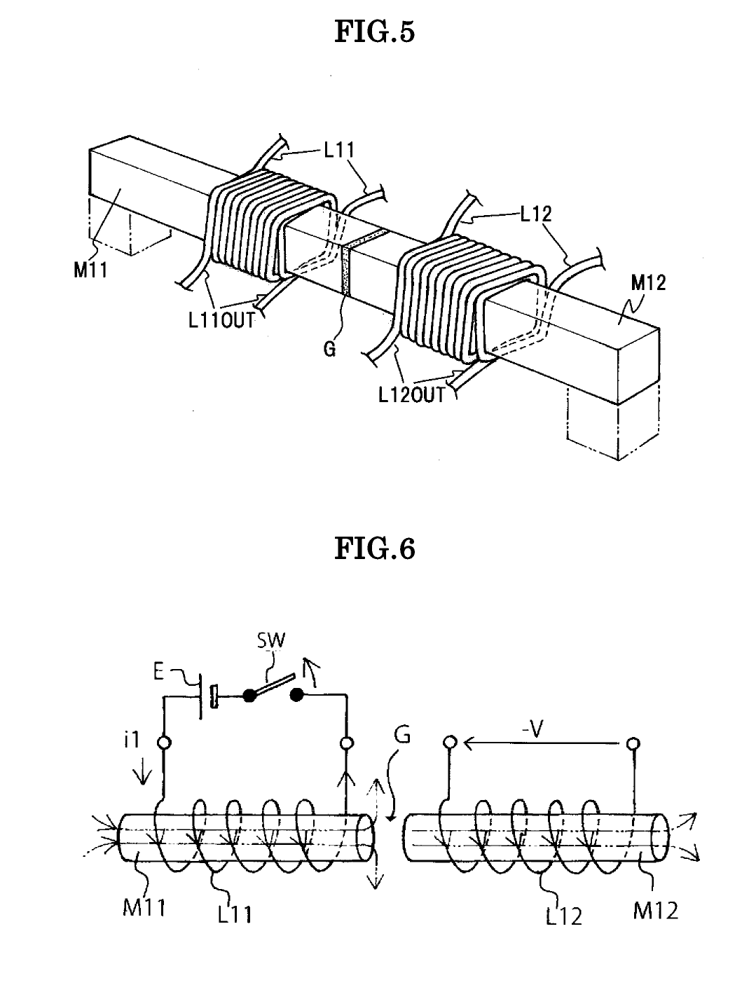

FIG. 4 shows an example of providing a winding in order to pick up the output as a transformer when the two coils L11, L12 are connected in parallel as shown in FIG. 3. FIG. 5 is an external perspective view in that case. Secondary windings L11OUT and L12OUT for picking up the output are wound around magnetic cores M11, M12, overlappedly on the coils L1, L2 which are connected to the DC power source E.

Next, referring to FIG. 6 which has the same configuration as that in FIG. 1, it is assumed that each coil current is decreased with time or the switch is opened, reversely with respect to the above case. In this case, quite reverse actions are applied mutually to the opposing coils.

In FIG. 6, the switch SW is initially closed, when assuming that the switch SW is abruptly opened in the initial state where current i1 flows in the coil L11. Also, in this case, an induced electromotive force −V is generated in the opposing coil L12 in accordance with a Lenz's law, in the direction of which is opposite to the direction in above case shown in FIG. 1.

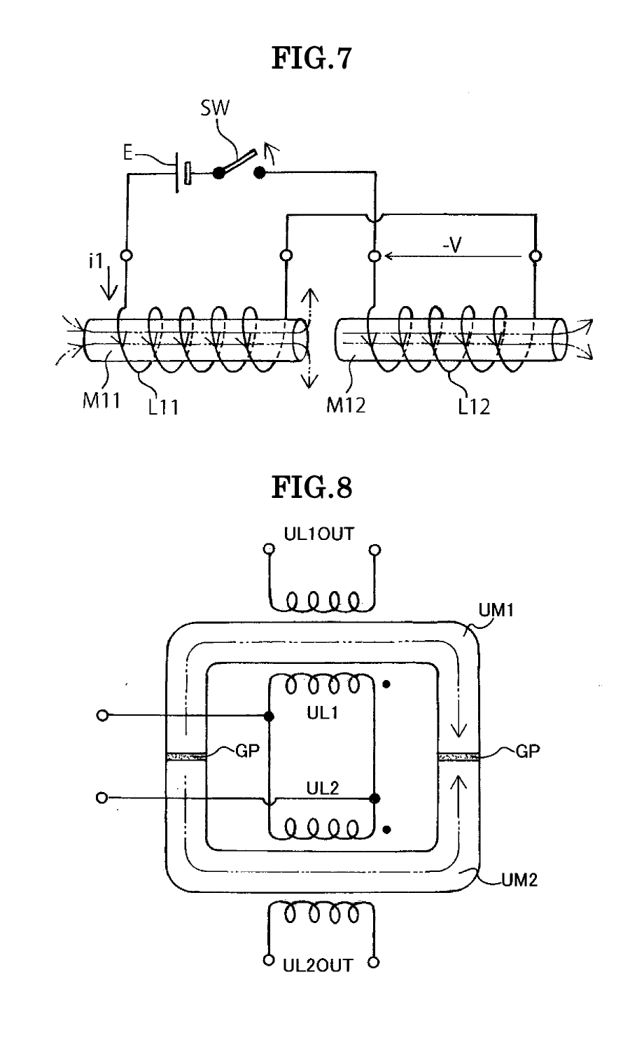

When the two coils L11, L12 are connected in series as shown in FIG. 7, the electromotive force generated in the coil L12 is oppositely directed to the current flowing in the coil L11, thereby causing an action which drastically prevents the current. This action is also caused by the induced electromotive force generated in the coil L11 by the magnetic field of the coil L12, giving the same effect of drastically decreasing the current of mutually opposing coils.

As such, when the current is decreased or is turned off, the magnetic fields of mutually opposing coils can be brought to zero in a much shorter time.

That is, in a transformer having the configuration of magnetic field such that a pair of coils repulsively acts each other, when current is increased just after the switch on the primary input side is closed, the current is mutually accelerated. In contrast, when the current is decreased or the switch is opened, the transformer gives the effect of suppressing the mutual current in a much shorter time. This effect acts to accelerate a change in magnetic flux with respect to time in the transformer.

According to a Faraday's law, it is apparent that this phenomenon effectively acts on the output voltage of a transformer which has a predetermined input voltage and coil turns.

Further, according to the non-patent literature 1, it is shown that when two coils form repulsive magnetic fields, a positive electromotive force (positive EMF), which is different from the electromotive force based on the conventional Faraday's law, is generated so as to accelerate the current.

Further, the non-patent literature 2 teaches the possibility that the generated positive electromotive force (positive EMF) is involved in the term which is higher than second time derivative of magnetic flux. That is, the higher the time rate of change in magnetic flux, the larger the positive electromotive force becomes.

Both the non-patent literatures 1 and the non-patent literature 2 teach that the coils and the transformer which configure repulsive magnetic fields are effective for the improvement of output and the improvement of efficiency.

Further, a transformer according to the present invention is more effective when driving with a precipitous spike-shaped rising and falling pulse current rather than with sinusoidal wave. That is, if the transformer is applied to an inverter for changing DC current to AC current, it can give the utmost effect.

Another significant point is to provide a proper gap between the two magnetic cores in order to prevent the magnetic fields formed by the two coils from canceling each other out and reducing the inductance to zero.

Next, a specific embodiment is described for a transformer according to the present invention.

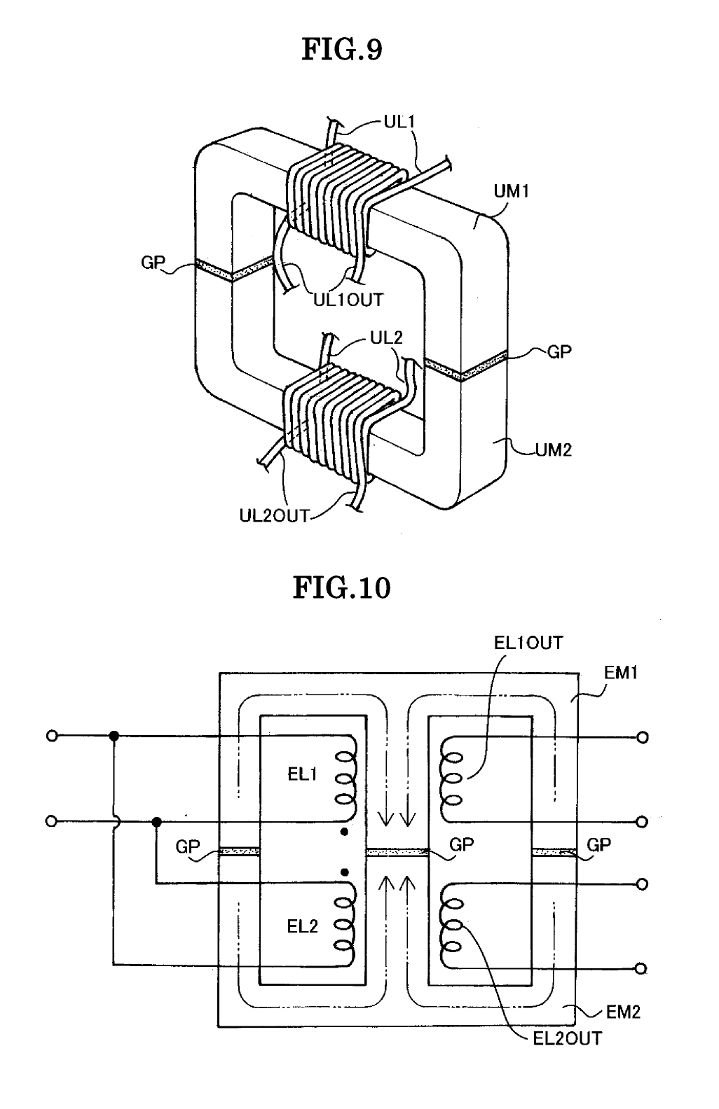

FIG. 8 is a structural view illustrating a first embodiment of a transformer according to the present invention, and FIG. 9 is a perspective view illustrating a first embodiment of a transformer according to the present invention. The transformer includes a magnetic field structure which has U-shaped magnetic cores UM1, UM2 opposed with a gap GP, with the upper and lower magnetic fields repulsively acting at the cross point.

According to this embodiment, as shown in FIGS. 8 and 9, two U-shaped cores UM1, UM2 are oppositely provided with the end of each core facing each other, sandwiching at the center a gap member GP made of nonmagnetic material (plastic, ceramic, and so forth). At the position where the core UM1 and the core UM2 are opposed, each of cores are provided with facing each end of U-shaped cores UM1, UM2 through the gap member GP therebetween.

A primary input is configured such that the wire connection of the primary coils UL1, UL2 is made by connecting in parallel between the starts of winding of coils UL1, UL2 and between the ends of winding of coils UL1, UL2, respectively. And, an output is taken out form the secondary coil UL1OUT, UL2OUT which are wound overlappedly on the primary coils UL1, UL2.

In such a configuration, the direction of magnetic field formed by one direction current is shown by a broken line with an arrow in FIG. 8. That is, the wire connection of coils UL1, UL2 of the above primary input forms a magnetic field such that the magnetic fields made by the magnetic cores UM1, UM2 repulsively act at the cross point of gap. That is, the magnetic field in the magnetic circuit formed by the magnetic core UM1 and the magnetic field in the magnetic circuit formed by the magnetic core UM2 act repulsively with the same polarity.

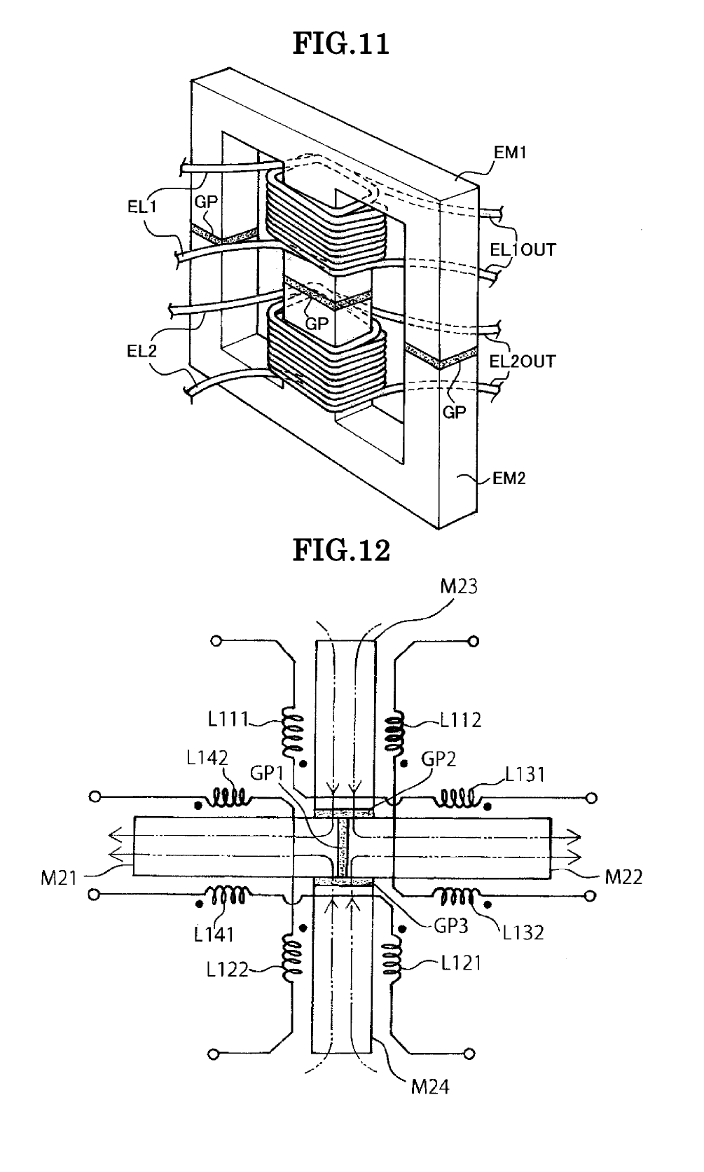

FIG. 10 is a structural view illustrating a second embodiment of a transformer according to the present invention, and FIG. 11 is a perspective view illustrating a second embodiment of a transformer according to the present invention. This transformer has a magnetic field structure such that E-shaped magnetic cores EM1, EM2 are opposed with a gap G, where an upper and lower magnetic fields act repulsively at the cross point.

According to this embodiment, as shown in FIGS. 10 and 11, two E-shaped cores EM1, EM2 are oppositely provided with the end of each core facing each other, sandwiching at the center a gap member GP made of nonmagnetic material (plastic, ceramic, and so forth). At the position where the core EM1 and the core EM2 are opposed, each of cores are provided with facing each end of E-shaped cores EM1, EM2 through the gap member GP therebetween.

A primary input is configured such that the wire connection of the primary coils EL1, EL2 is made by connecting in parallel between the starts of winding of coils EL1, EL2 and between the ends of winding of coils EL1, EL2, respectively. And, an output is taken out form the secondary coils EL1OUT, EL2OUT which are wound overlappedly on the primary coils EL1, EL2.

In such a configuration, the direction of magnetic field formed by one direction current is shown by a broken line with an arrow in FIG. 10. That is, the wire connection of coils EL1, EL2 of the above primary input forms a magnetic field such that the magnetic fields made by the magnetic cores EM1, EM2 repulsively act at the cross point of gap. That is, the magnetic field in the magnetic circuit formed by the magnetic core EM1 and the magnetic field in the magnetic circuit formed by the magnetic core EM2 act repulsively with the same polarity.

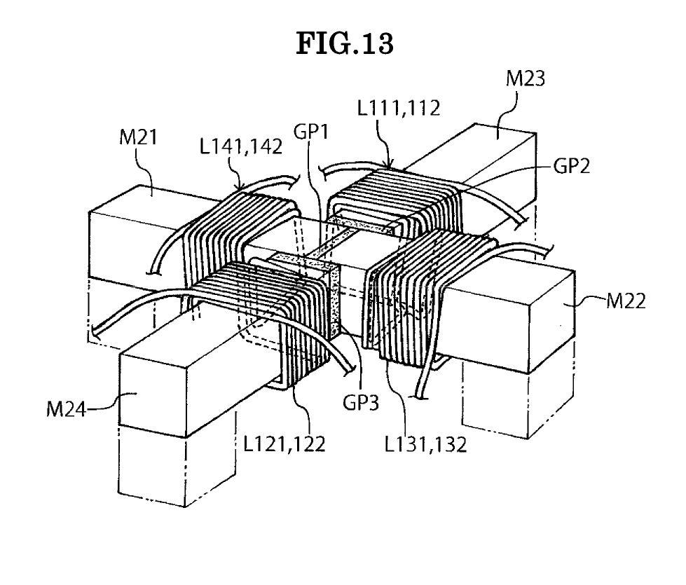

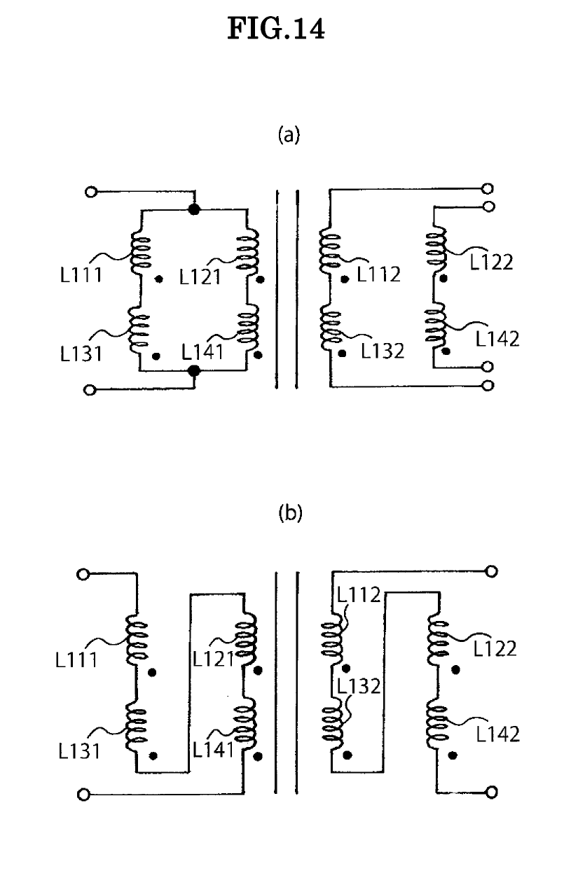

FIG. 12 is a structural view illustrating a third embodiment of a transformer according to the present invention, FIG. 13 is a perspective view illustrating a third embodiment of a transformer according to the present invention, and FIGS. 14(a) and 14(b) are circuit diagrams illustrating the wire connection states of each coil in the third embodiment of a transformer according to the present invention. This transformer has a magnetic field structure crossing in a cross shape, where upper, lower, right and left magnetic fields act repulsively at the cross point.

According to this embodiment, as shown in FIGS. 12 and 13, two rod-shaped cores EM21, EM22 are oppositely provided with the end of each core facing each other, sandwiching at the center a gap member GP1 made of nonmagnetic material (plastic, ceramic, and so forth). At the position where the core M21 and the core M22 are opposed, rod-shaped cores M23, M24 are provided with each end is directed so as to sandwich gap members GP2, GP3 from a direction orthogonal to these cores M21, M22.

Further, coils L111, L112 are wound around M23, coils L121, L122 are wound around M24, coils L131, L132 are wound around M22, and coils L141, L142 are wound around M21, and these coils form a double-coil respectively.

And, when a primary input and a secondary output are connected respectively in parallel, the wire connection of the coils L111, L112, L121, L122, L131, L132, L141, L142 is configured such that a serial connection of the coil L111 and the coil L131 and a serial connection of the coil L121 and the coil 141 are connected in parallel as shown in FIG. 14(a), whereby the primary input is configured. At the same time, one output of the secondary output is taken out from the serial connection of the coil L112 and the coil 132, while the other output of the secondary output is taken out from the serial connection of the coil L122 and the coil L142.

Further, when the primary input and the secondary output are connected respectively in series, the serial connection of the coil L111 and coil L131 and the serial connection of the coil L121 and the coil 141 are connected in series as shown in FIG. 14(b), whereby the primary input is configured. At the same time, the serial connection of the coil L112 and the coil 132 and the serial connection of the coil L122 and the coil L142 are connected in series, whereby the secondary output is configured.

In such a configuration, the direction of magnetic field formed by one direction current is shown by a broken line with an arrow in FIG. 12. That is, the wire connection of coils L111, L112, L121, L122, L131, L132, L141, L142 of the above primary input forms a magnetic field such that the magnetic fields made by the magnetic cores M23, M24 repulsively act at the cross point of gap and separately flow in a right and left direction into magnetic cores M21, M22. That is, the magnetic field in the magnetic circuit formed by the magnetic cores M21, M22 and the magnetic field in the magnetic circuit formed by the magnetic cores M23, M24 act repulsively with the same polarity.

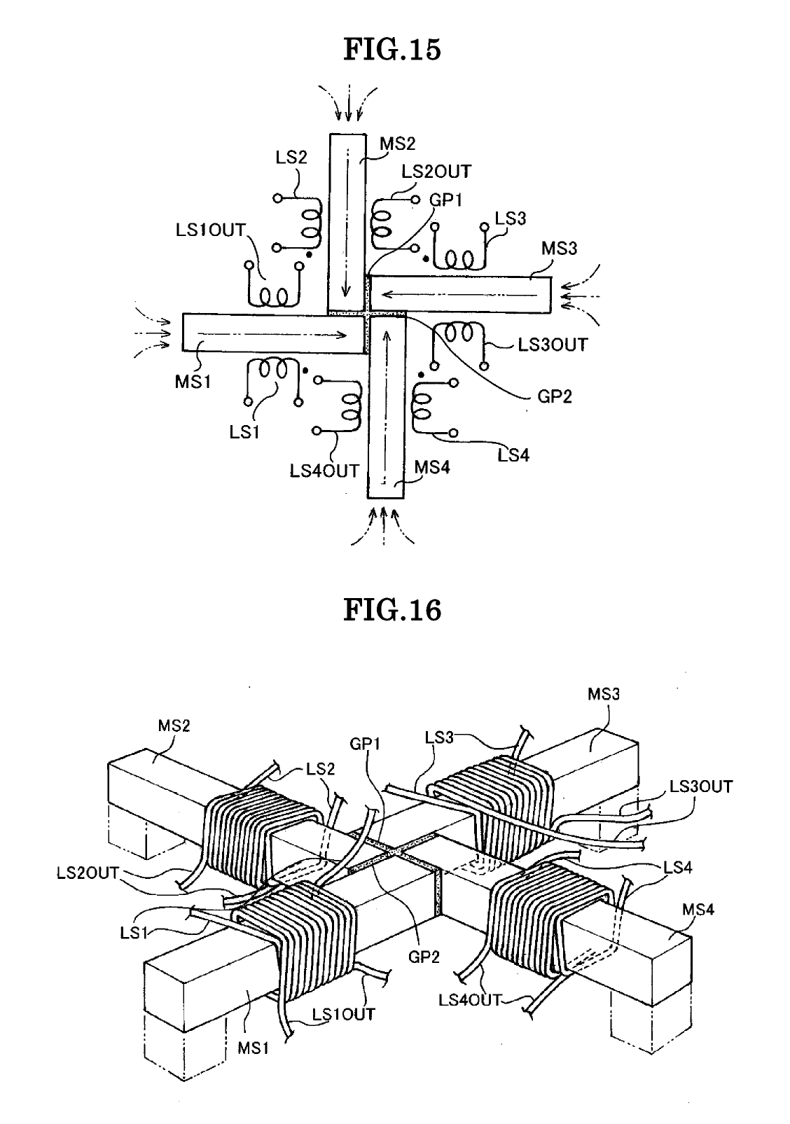

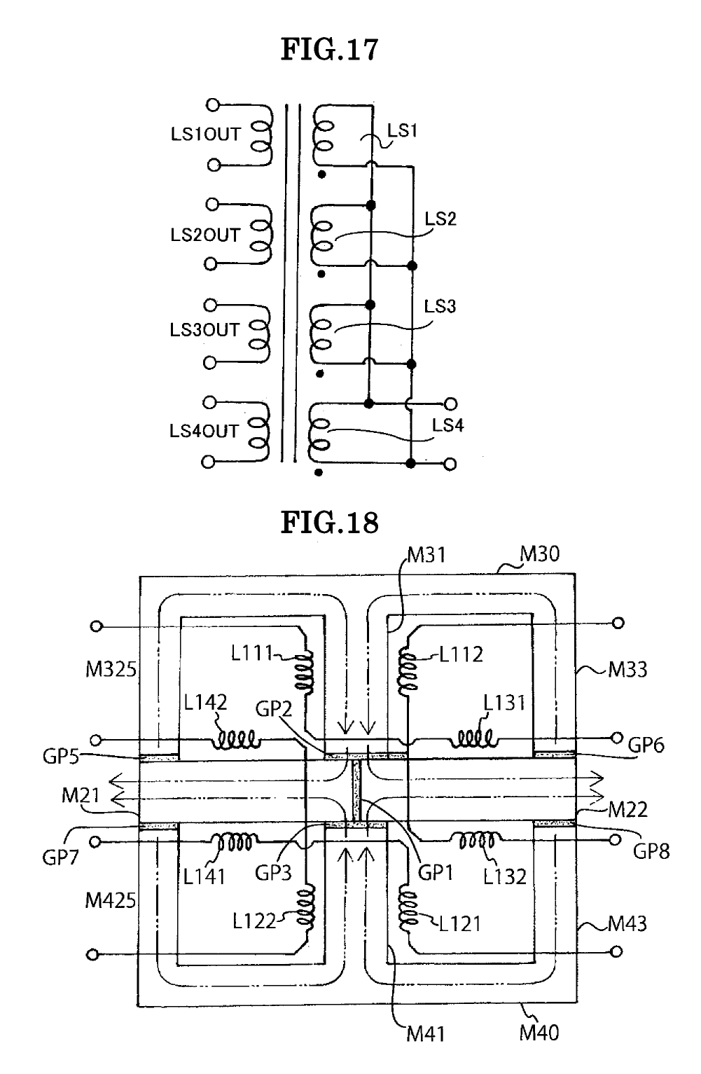

FIG. 15 is a structural view illustrating a fourth embodiment of a transformer according to the present invention; FIG. 16 is a perspective view illustrating a fourth embodiment of a transformer according to the present invention, FIG. 17 is a connection wiring diagram illustrating the wire connection state of each coil in the fourth embodiment of a transformer according to the present invention. This transformer has a magnetic field structure crossing in a cross shape, where a top, bottom, right and left magnetic fields act repulsively at the cross point.

According to this embodiment, as shown in FIGS. 15 and 16, four rod-shaped cores MS1, MS2, MS3, MS4 are oppositely provided with the end of each core facing the side of end of another rod-shaped core, sandwiching at the center a gap members GP1, GP2 made of nonmagnetic material (plastic, ceramic, and so forth).

Further, the primary coils LS1, LS2, LS3, and LS4 are wound around the rod-shaped cores MS1, MS2, MS3, MS4 respectively, and the secondary coils LS1OUT, LS2OUT, LS3OUT, and LS4OUT are wound overlappedly around the primary coils LS1, LS2, LS3, and LS4.

The wire connections of primary coils LS1, LS2, LS3, and LS4 are all formed in parallel, and secondary output is taken out from the secondary coils LS1OUT, LS2OUT, LS3OUT, and LS4OUT which are wound overlappedly on the primary coils LS1, LS2, LS3, and LS4.

In such a configuration, the direction of magnetic field formed by one direction current is shown by a broken line with an arrow in FIG. 15. That is, the wire connection of the above primary coils LS1, LS2, LS3, LS4 is formed such that the magnetic fields made by the magnetic cores MS1, MS2, MS3, MS4 repulsively act at the cross point of gap.

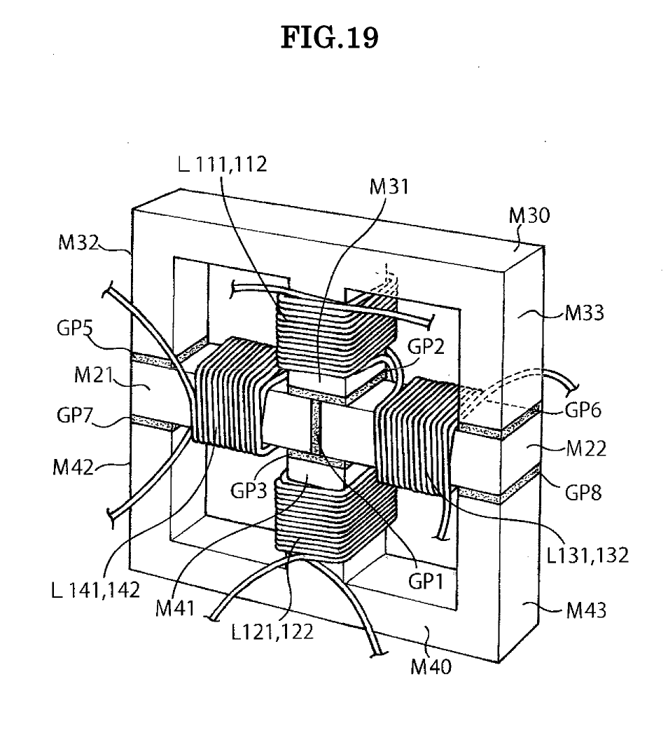

FIG. 18 is a structural view illustrating a fifth embodiment of a transformer according to the present invention, and FIG. 19 is a perspective view illustrating a fifth embodiment of a transformer according to the present invention. This transformer employs E type cores M30, M40 in place of the top and bottom magnetic cores M23, M24 of a transformer according to the third embodiment shown in FIG. 12, having a structure in which a part of the magnetic circuit is closed. The same or corresponding parts in FIGS. 18, 19 as those in FIGS. 12, 13 bear the same symbols. The way of wire connection for each coil is not described here, because it is the same as that of the third embodiment according to the present invention described above.

In FIG. 18, the center leg M31 of E type core M30 corresponds to the core M23 of the embodiment in FIG. 12, and the center leg M41 of E type core M40 corresponds to the core M24 of the embodiment in FIG. 12. Further, the end legs M32, M33 of E type core M30 are oppositely provided to the cores M21, M22 via gap members GP5, GP6 respectively, while the end legs M42, M43 of E type core M40 are oppositely provided to the cores M21, M22 via gap members GP7, GP8 respectively.

And, the coils L111, L112 are wound around the leg M31 of E type core M30, while coils L121, L122 are wound around the leg M41 of E type core M40 respectively

In such a configuration, the direction of magnetic field formed by one direction current is shown by a broken line with an arrow in FIG. 18. That is, the wire connection of coils L111, L112, L121, L122, L131, L132, L141, L142 of the above primary input, which is the same as that of the third embodiment, forms a magnetic field such that the magnetic fields made by the E type cores M30, M40 repulsively act at the cross point of gap and separately flow in a right and left direction into the magnetic cores M21, M22. That is, the magnetic field in the magnetic circuit formed by the E type core M30 and the magnetic field in the magnetic circuit formed by the E type core M40 act repulsively with the same polarity.

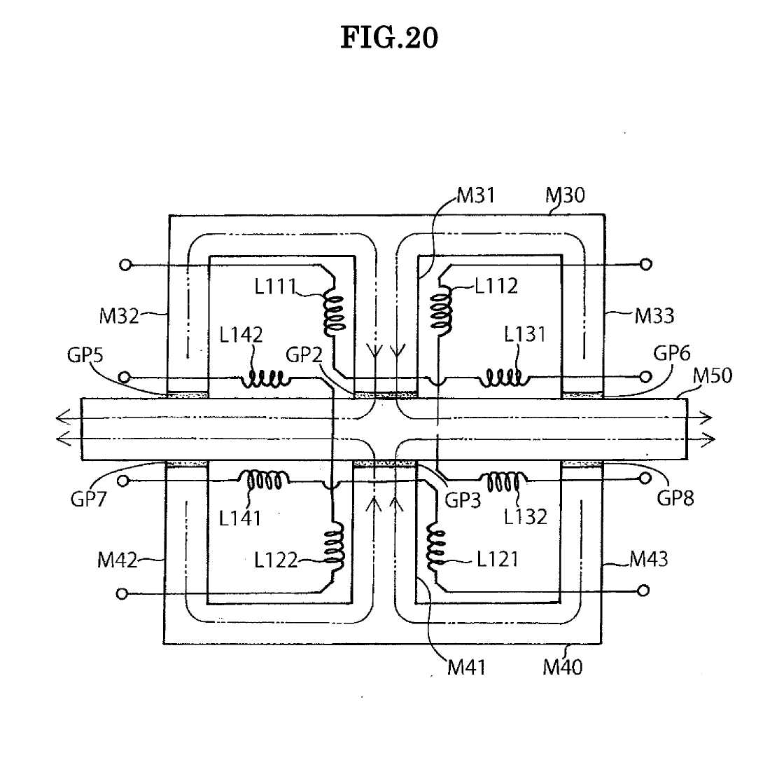

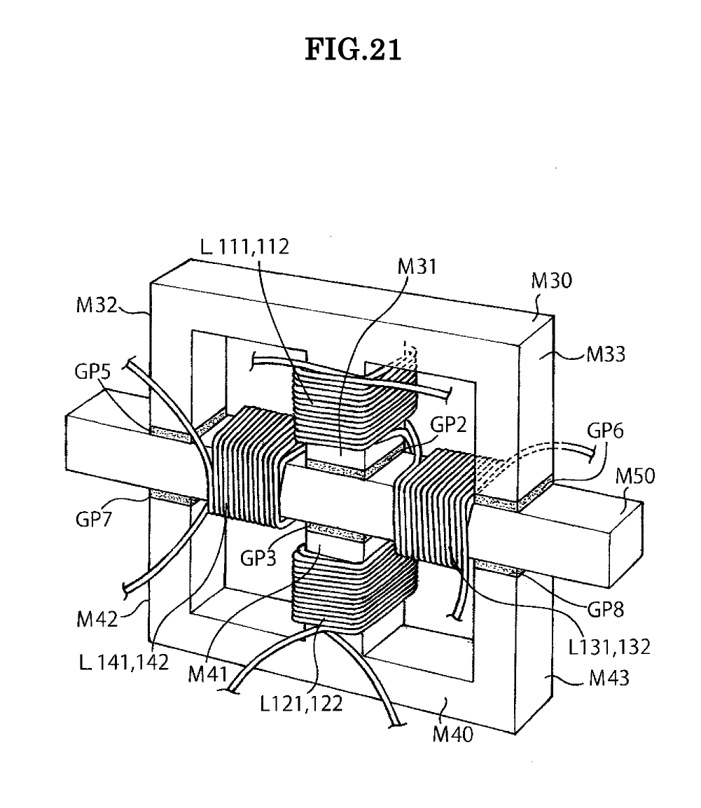

FIG. 20 is a structural view illustrating a sixth embodiment of a transformer according to the present invention, and FIG. 21 is a perspective view illustrating a sixth embodiment of a transformer according to the present invention. This transformer has a structure including a magnetic core M50 integrating the magnetic cores M21, M22 at the center of a transformer according to the fifth embodiment shown in FIG. 18. The same or corresponding parts in FIGS. 20, 21 as those in FIGS. 18, 19 bear the same symbols. The way of wire connection for each coil is not described here, because it is the same as that of the first embodiment according to the present invention described above.

And, the coils L131, L132, L141, L142 are wound around the core M50 respectively in this sixth embodiment.

Further, in such a configuration, the direction of magnetic field formed by one direction current is shown by a broken line with an arrow in FIG. 20. That is, the wire connection of coils L111, L112, L121, L122, L131, L132, L141, L142 of the above primary input, which is the same as that of the fifth embodiment, forms a magnetic field such that the magnetic fields made by the E type cores M30, M40 repulsively act at the cross point of gap and separately flow in a right and left direction into the magnetic core M50. That is, the magnetic field in the magnetic circuit formed by the E type core M30 and the magnetic field in the magnetic circuit formed by the E type core M40 act repulsively with the same polarity

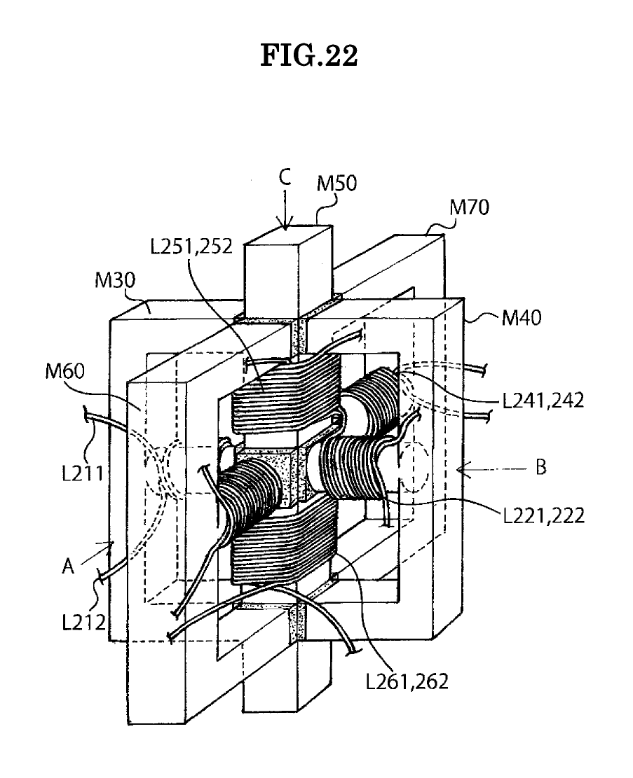

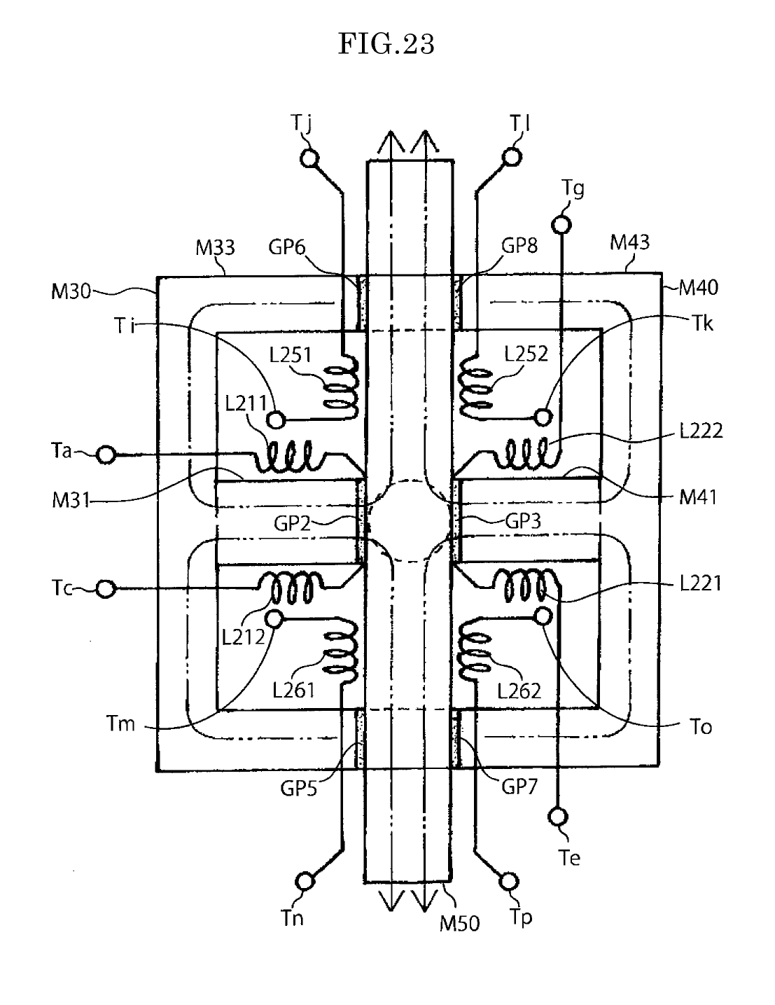

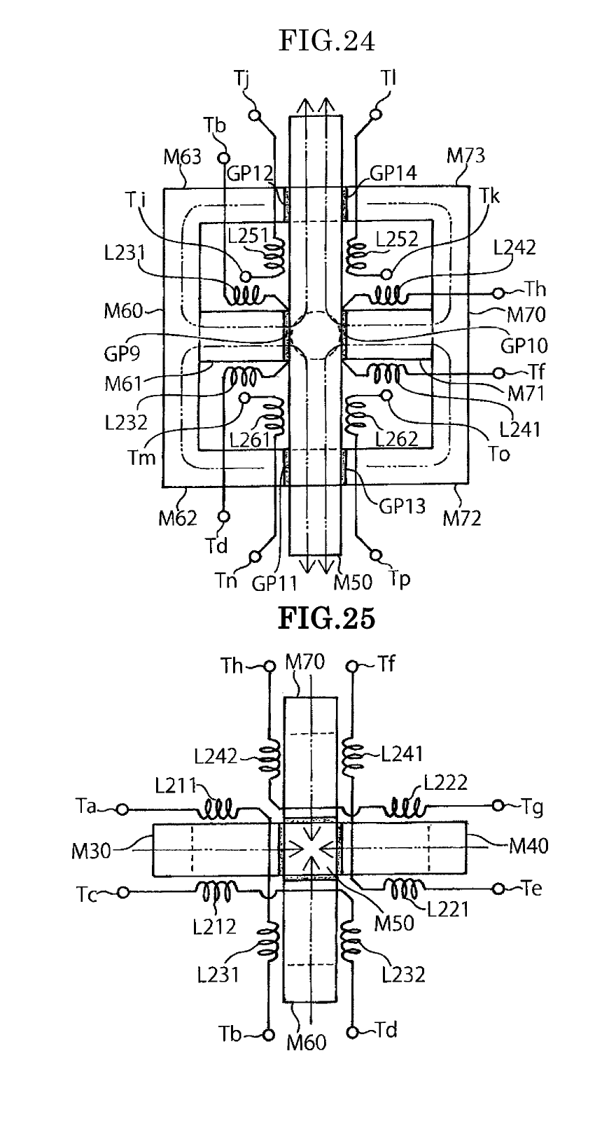

FIG. 22 is a structural view illustrating a seventh embodiment of a transformer according to the present invention, FIG. 23 is a view when the transformer is viewed from the direction of arrow A in FIG. 22, FIG. 24 is a view when the transformer is viewed from the direction of arrow B in FIG. 22, and FIG. 25 is a view when the transformer is viewed from the direction of arrow C in FIG. 22. The same or corresponding parts in FIGS. 22 to 25 as those in FIGS. 20, 21 bear the same symbols.

In this seventh embodiment, the core M50 provided at the center in the sixth embodiment shown in FIG. 20 is formed in a prism shape, and E type cores M30, M40 are provided with respect to the core M50 via gap members GP2, GP3, GP5 to GP8, while opposing E type cores M60, M70 are provided via gap members GP9 to GP14 on the surfaces of the core M50 which are different from the surfaces on which the E type cores M30, M40 are located.

Here, the center leg M61 and both end legs M62, M63 of the E type core M60 come into contact with the core M50 via the gap members GP9, GP11, and GP12 respectively, while the center leg M71 and both end legs M72, M73 of the E type core M70 come into contact with the core M50 via the gap members GP10, GP13, and GP14 respectively.

Further, coils L211, L212 are wound around the leg M31 of E type core M30, coils L221, L222 are wound around the leg M41 of E type core M40, coils L231, L232 are wound around the leg M61 of E type core M60, and coils L241, L242 are wound around the leg M71 of E type core M70. Further, coils L251, L252 are wound on the upper side of the core M50 and coils L261, L262 are wound on the lower side of the core M50. Each terminal of these coils is shown by Ta to To.

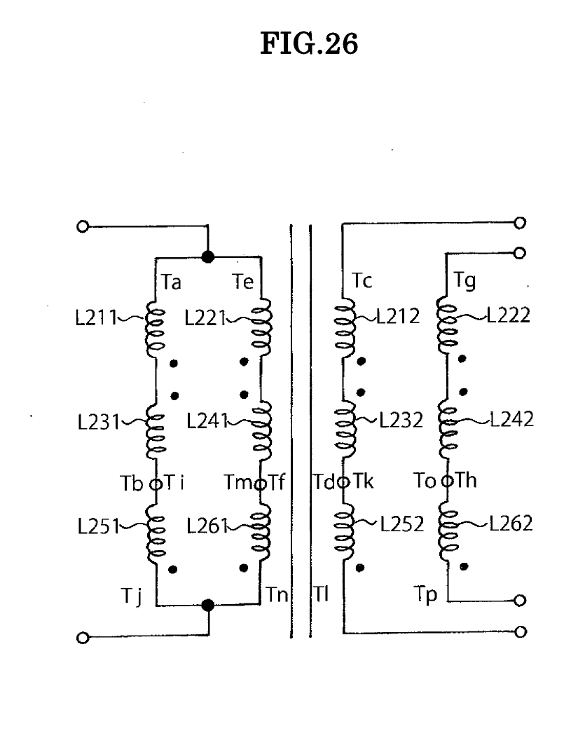

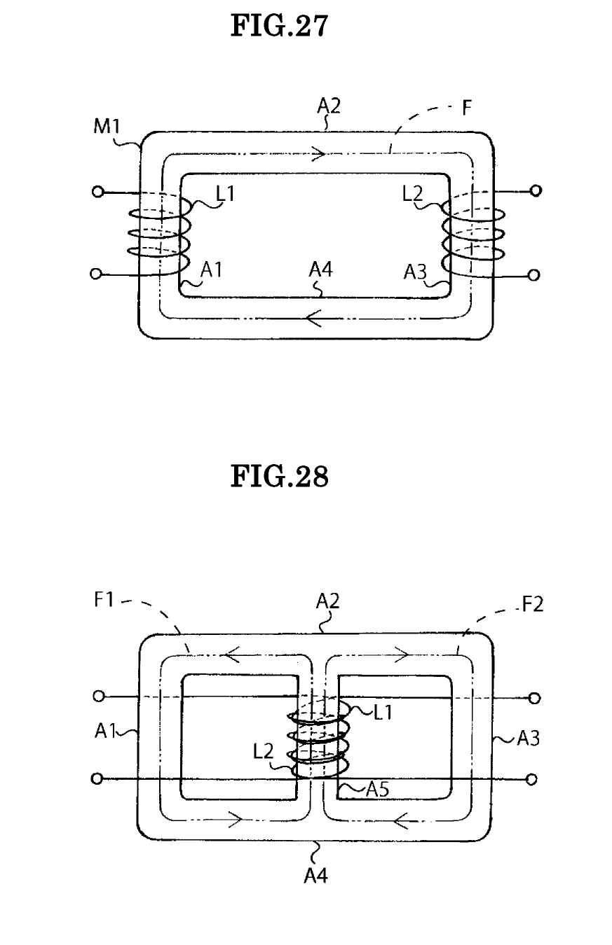

FIG. 26 shows an example of the wire connection of these coils L211, L212, L221, L222, L231, L232, L241, L242, L251, L252, L261, L262. In FIG. 26, black points represent the start point of winding for each coil.

In this case, the primary input is configured with a parallel connection of a serial connection of coils L211, L231, L251 and a serial connection of coils L221, L241, L261.

Further, one secondary output is configured with a serial connection of coils L212, L232, L252 and the other secondary output is configured with a serial connection of coils L222, L242, L262.

In this case, all of the magnetic fields made by the legs M31, M41, M61, M72 of E type cores M30, M40, M60, M70 form a magnetic structure such that all of the magnetic fields act repulsively at the center of the central I type magnetic core M50, separately flow in an upper and lower direction from the center of the core M50, and partially flow outside from the upper and lower projections of the core M50. That is, the magnetic fields made by the legs M31, M41, M61, M72 of E type cores M30, M40, M60, M70 and the magnetic field in the core M50 repulsively act each other in the same direction.

### Variation

Although embodiments according to the present invention are described above, the configuration of device and so forth are not limited to the above-mentioned embodiments. Further, the configuration and variation of each embodiment as described above can be applied in proper combination as long as no conflict occurs.

### INDUSTRIAL APPLICABILITY

A transformer according to the present invention is most effective if it is used as a transformer for an inverter which converts DC current to AC current.

### Description of Symbols

UL1, UL2, UL1OUT, UL2OUT, ELL EL2, EL1OUT, EL2OUT, LS1, LS2, LS3, LS4, LS1OUT, LS2OUT, LS3OUT, LS4OUT, L111, L112, L121, L122, L131, L132, L141, L142, L211, L212, L221, L222, L231, L232, L241, L242, L251, L252, L261, L262—coil

UM1, UM2—U type core

M21, M22, M23, M24, MS1, MS2, MS3, MS4—core

EM1, EM2, M30, M40, M60, M70—E type core

M50—I type core

GP, GP1, GP2, GP3, GP4, GPS, GP6, GP7, GP8, GP9, GP10, GP11, GP12, GP13, GP14—gap member

1. A transformer comprising two or more cores, and a primary coil and a secondary coil which are wound around said cores, wherein two or more magnetic circuits formed by said cores and said primary coil or said secondary coil have a combination generating lines of magnetic force which repulsively act each other, and the cores forming a combination where said magnetic circuits generate lines of magnetic force which repulsively act each other are provided with at least one or more gaps and two or more of said primary coils are provided and connected in series or in parallel so as to generate said lines of magnetic force which repulsively act each other.

2. The transformer according to claim 1, wherein just after the power supply to said primary coil is switched from OFF to ON or ON to OFF, the electric power generated in said secondary coil is taken outside of the transformer.

3. The transformer according to claim 1 or 2, wherein a gap member made of a non-magnetic material is provided in said gap.
